(19) United States
(12) Patent Application Publication
(10) Pub. No.: US 2025/0121713 A1
(43) Pub. Date: Apr. 17, 2025

(54) STATIONARY VEHICLE BATTERY CHARGER WITH MATRIX CONVERTER AND HALF-BRIDGE MOSFETS

(71) Applicant: BorgWarner Inc., Auburn Hills, MI (US)

(72) Inventor: Daniel Brown, Freeville, NY (US)

(21) Appl. No.: 18/379,868

(22) Filed: Oct. 13, 2023

(51) Int. Cl. B60L 53/22; H02J 7/00; H02M 5/293

(52) U.S. Cl. CPC B60L 53/22; H02J 7/007; H02M 5/2932; B60L 2210/20; H02J 2207/20

(57) ABSTRACT

A stationary vehicle battery charger for charging vehicle batteries in battery electric vehicles (BEVs) includes a plurality of MOSFET modules, electrically connected to form a matrix converter, comprising a plurality of MOSFET switches, each MOSFET switch including a body diode and capable of bidirectional electrical current flow while the MOSFET switch is conductive, such that a MOSFET switch from a first MOSFET module and a MOSFET switch from a second, different MOSFET module are electrically coupled so that the body diodes prevent bidirectional current flow while the MOSFET switch from the first MOSFET module and the MOSFET switch from the second, different MOSFET module are non-conductive.

### TECHNICAL FIELD

The present application relates to charging vehicle batteries and, more particularly, to switching circuits used to carry out vehicle charging.

### BACKGROUND

Modern vehicles are increasingly propelled at least partially or wholly by electric motors. The vehicles, often referred to as battery electric vehicles (BEVs), include a vehicle battery and one or more electric motors that drive the vehicle wheels. The vehicle batteries are periodically coupled to a stationary battery charger. As motorists purchase increasing quantities of BEVs, vehicle chargers will increase in availability. Many electrical components are not currently optimized for use with battery chargers that charge vehicles.

### SUMMARY

In one implementation, a stationary vehicle battery charger for charging vehicle batteries in battery electric vehicles (BEVs) includes a plurality of MOSFET modules, electrically connected to form a matrix converter, comprising a plurality of MOSFET switches, each MOSFET switch including a body diode and capable of bidirectional electrical current flow while the MOSFET switch is conductive, such that a MOSFET switch from a first MOSFET module and a MOSFET switch from a second, different MOSFET module are electrically coupled so that the body diodes prevent bidirectional current flow while the MOSFET switch from the first MOSFET module and the MOSFET from the second, different MOSFET module are non-conductive.

In another implementation, a stationary vehicle battery charger for charging vehicle batteries in BEVs includes a plurality of MOSFET switch pairs, each electrically configured to form a half bridge, and the plurality of MOSFET switch pairs electrically connected to form a matrix converter, each MOSFET switch of the plurality of MOSFET switch pair including a body diode and capable of bidirectional electrical current flow while the MOSFET switch is conductive, such that a MOSFET switch from a first MOSFET switch pair and a MOSFET switch from a second, different MOSFET switch pair are electrically coupled so that the body diodes prevent bidirectional current flow while the MOSFET switch from the first MOSFET switch pair and the MOSFET switch from the second, different MOSFET switch pair are non-conductive.

### BRIEF DESCRIPTION OF THE DRAWINGS

FIG. 1 is a block diagram depicting an implementation of a battery electric vehicle (BEV) that receives charge from a stationary battery charger;

FIG. 2 is a circuit diagram depicting a portion of an implementation of a DC fast charger; and

FIG. 3 is a circuit diagram depicting a portion of an implementation of a DC fast charger;

FIG. 4 is a circuit diagram depicting a portion of an implementation of a DC fast charger; and

FIG. 5 is a circuit diagram depicting a portion of an implementation of a DC fast charger.

### DETAILED DESCRIPTION

Vehicle battery chargers can receive electrical power from a grid and deliver the electrical power to a battery electric vehicle (BEV). In some configurations, the vehicle battery chargers can provide Alternating Current (AC) electrical power to the BEV, which uses an on-board battery charger to convert the AC electrical power to DC electrical power that is used to charge the vehicle battery. Other types of vehicle battery chargers can be stationary and located apart from the BEV. These stationary vehicle battery chargers can be referred to as Direct Current (DC) fast chargers for vehicles or “Level 3” chargers that receive AC electrical power from an electrical grid, convert the AC electrical power to DC electrical power, and then supply the DC electrical power to the vehicle battery. The stationary vehicle battery chargers can include MOSFET switches that are arranged to control the bidirectional flow electrical current. Given a bidirectional flow of electrical current within these stationary vehicle battery chargers, it can be helpful to impede the flow of current in more than one direction while Metal Oxide Semiconductor Field Effect Transistors (MOSFETs) are “off’ or “non-conductive.”

As part of carrying out its functionality, the stationary vehicle battery chargers can include half-bridge MOSFET modules, enabling AC-AC electrical power conversion. The MOSFET module can be implemented as an individual component including two MOSFET switches that are electrically connected in series and form a half bridge. The MOSFET module can be a commercially-available unit that may be optimized for applications other than stationary battery chargers, such for use as a motor controller. The integrated design and packaging of the MOSFET switches as part of the module may yield some performance advantages over separately combined discrete MOSFET switches, such as a higher electrical power rating or a lower gate voltage. But given optimization for other applications, the MOSFET module may not be inherently configured to passively prevent the bi-directional flow of electrical current. However, in some implementations, the half bridge MOSFET circuit can be implemented using MOSFET switch pairs that are not part of a MOSFET module, but include two discrete MOSFETs that are electrically connected in a similar architecture. The MOSFETs included in the MOSFET module each include body diodes that electrically connect the source to the drain and permit the flow of electrical current in one direction while the MOSFETs are in the off, or non-conductive, state while preventing the flow of current in the opposite direction. In the proposed circuit, each phase of AC electrical power provided by the electrical grid can electrically connect to one MOSFET switch included in a MOSFET module and one MOSFET switch included in another, separate MOSFET module to ensure that the body diodes of each MOSFET electrically connected to one phase of the grid oppose each other thereby preventing the flow of current when the MOSFETs are not rendered conductive such that each leg of each half bridge is able to have bidirectional shut-off. While the term MOSFET is used, it should be appreciated that this term should be broadly construed to include other semiconductor switches, such as Insulated Gate Bipolar Transistors (IGBTs).

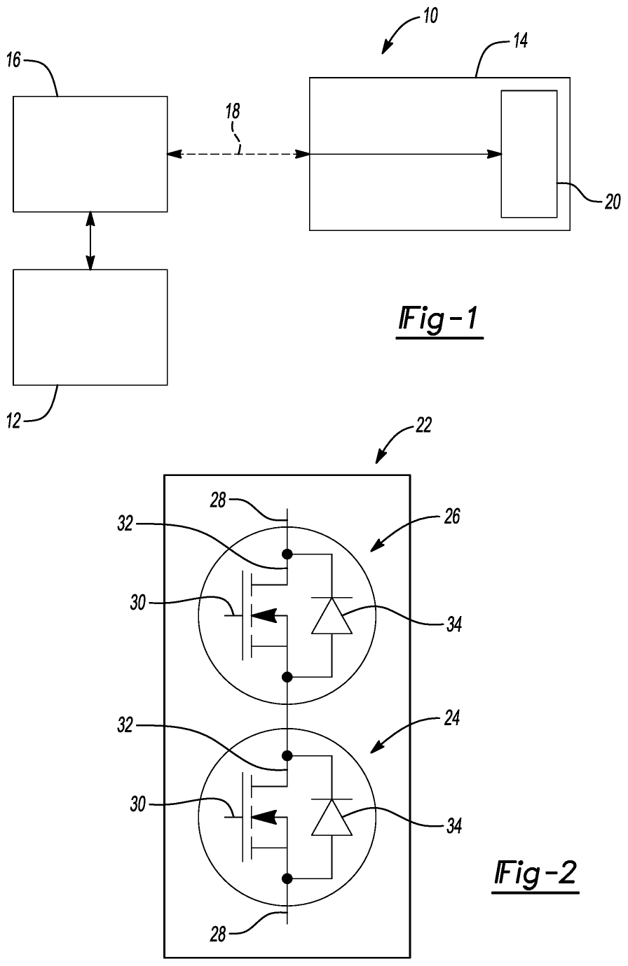

Turning to FIG. 1, an implementation of an electrical system 10 is shown including an electrical grid 12 and a battery electric vehicle (BEV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase 50-60 Hz. However, this voltage range can be different.

A stationary vehicle charging station, also referred to here as a DC fast charger 16, can receive AC electrical power from the grid 12, rectify the AC electrical power into DC electrical power, and provide the DC electrical power to the BEV 14. The DC fast charger 16 can be geographically fixed, such as a charging station located in a vehicle garage or in a vehicle parking lot. The DC fast charger 16 can include an input terminal that receives the AC electrical power from the grid 12 and communicates the AC electrical power to a BEV battery 20 directly, bypassing an on-board vehicle battery charger included on the BEV 14. A charging cable 18 can detachably connect with an electrical receptacle on the BEV 14 and electrically link the DC fast charger 16 with the BEV 14 so that DC electrical power can be communicated between the DC fast charger 16 and the BEV battery 20. The DC fast charger 16 can receive 480 VAC from the grid 12 and have a power rating of 60-360 kW provided to the BEV 14. This type of DC fast charging may be referred to as Level 3 EV charging. However, the stationary vehicle charging station can be implemented using different standards. The term “battery electric vehicle” or “BEV” can refer to vehicles that are propelled, either wholly or partially, by electric motors. BEV can refer to electric vehicles, plug-in electric vehicles, hybrid-electric vehicles, and battery-powered vehicles. It should be viewed as encompassing passenger vehicles as well as commercial vehicles.

The BEV battery 20 can supply DC electrical power controlled by power electronics to the electric motors that propel the BEV 14. The BEV battery 20 or batteries are rechargeable and can include lead-acid batteries, nickel cadmium (NiCd), nickel metal hydride, lithium-ion, and lithium polymer batteries. A typical range of vehicle battery voltages can range from 100 to 1000V of DC electrical power (VDC). A control system, implemented as computer-readable instructions executable by a microprocessor, can be stored in non-volatile memory and called on to control functionality of the DC fast charger 16. The DC fast charger 16 can include a matrix converter on a primary side that functions as an AC-AC power system that converts three-phase voltage from the grid 12 into a high frequency bipolar AC voltage that can be supplied to the primary wire of a transformer. A secondary side of the matrix converter can be electrically coupled to a secondary wire of the transformer and include passive electrical components, such as diodes, or active electrical components, such as field effect transistors, to rectify AC electrical power into DC electrical power.

FIG. 2 depicts an implementation of a MOSFET module 22 used as part of a seven-switch matrix converter within the DC fast charger 16. The MOSFET module 22 can include MOSFET switch A 24 and MOSFET switch B 26. Each MOSFET switch 24, 26 can include a source 28, a gate 30, and a drain 32 as well as a body diode 34 that electrically links the source 28 and the drain 32. The MOSFET switch A 24 can be electrically connected to MOSFET switch B 26 in series. The MOSFET switches 24, 26 can be bidirectional or reverse-blocking switches such that they are four-quadrant switches capable of conducting positive or negative on-state current and blocking positive or negative off-state voltage implemented using Silicon Carbide (SiC) MOSFETs. However, other types of MOSFETs can be used, such as Gallium Nitride (GaN). One commercially available example of the MOSFET module 22 is the EAB450M12XM3 Automotive Qualified 1200 V, 450 A All-Silicon Carbide Conduction Optimized, Half-Bridge module offered by Wolfspeed. The matrix converter used within the DC fast charger 16 can be an indirect matrix converter or a direct matrix converter. An implementation of an indirect matrix converter is shown and described in U.S. patent application Ser. No. 18/226,389 the contents of which are hereby incorporated by reference. An implementation of a direct matrix converter is shown and described in U.S. patent application Ser. No. 18/223,778 the contents of which are hereby incorporated by reference. In one implementation, the matrix converter can be modularized such that the matrix converter can be combined with (an) other matrix converter(s) for increased electrical power ratings. For example, one matrix converter can be rated at 60 kW, and six matrix converters can be combined for a rating of 360 kW.

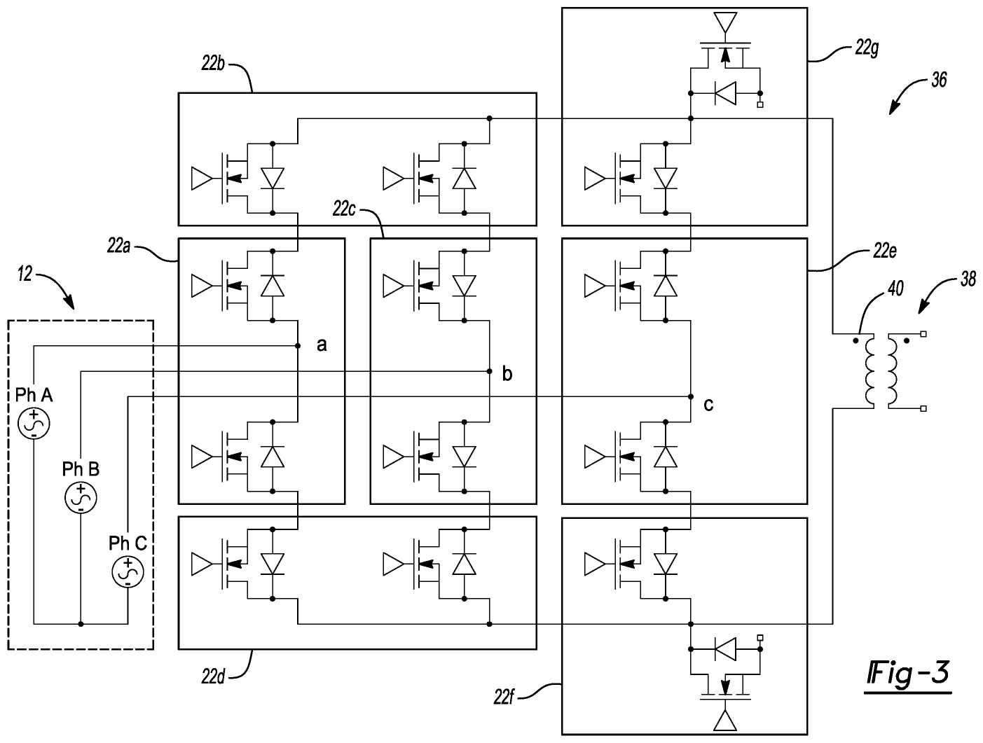

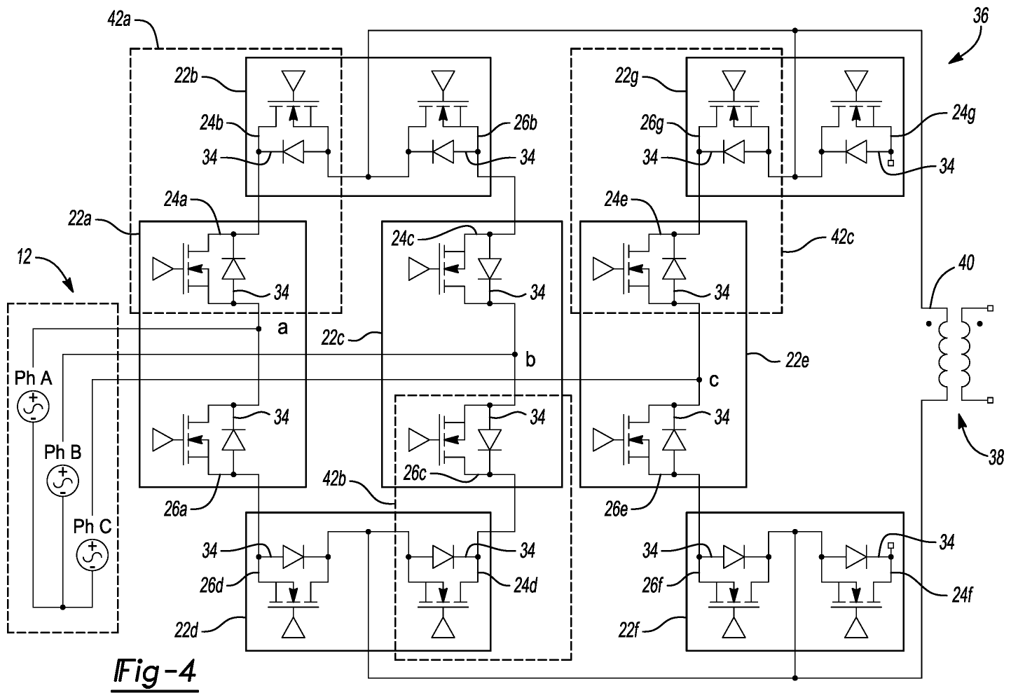

FIGS. 3 and 4 depicts an implementation of a matrix converter 36, capable of AC-AC electrical power conversion, included in the stationary vehicle battery charger 16. The matrix converter 36 can be electrically coupled to the electrical grid 16 via three phase wires or legs (Ph A, Ph B, Ph C). The matrix converter 36 can include seven MOSFET modules 22a-22g electrically coupled to a primary wire 38 of a transformer 36. Six MOSFET modules 22a-f can be electrically coupled to three legs of the electrical grid Ph A, Ph B, Ph C and nodes a, b, c. A seventh MOSFET module 22g can be wired in parallel with MOSFET modules 22e and 22f, and with the primary winding 40 of the transformer 38. Each of the MOSFET modules 22a-22g include a MOSFET switch A 24a-24g and a MOSFET switch B 26a-26g. The configuration of the MOSFET modules 22a-22g can prevent the bidirectional flow of current with the MOSFET switches are “off” or “non-conductive” such that the electrical current and voltage at the gate are low or substantially zero.

Cross-module pairs 42a-42c of MOSFET switches 24, 26 can prevent the flow of electrical current in more than one direction. Each MOSFET switch 24, 26 can prevent the flow of electrical current in one direction when the MOSFET switch 24, 26 is “off” or “non-conductive.” However, the body diode 34 included in each MOSFET switch 24, 26 can permit the flow of electrical current in one direction when the MOSFET switch 24, 26 is non-conductive. The arrangement of MOSFET modules 22 can configure the body diodes 34 so that they prevent the bidirectional flow of electrical current while the MOSFET switches 24, 26 are non-conductive. The body diodes 34 in MOSFET switches 24, 26 from different MOSFET modules 22 can oppose each other to prevent the flow of electrical current. For example, a first cross-module pair 42a of MOSFET switches 24a and 24b are electrically coupled so that the body diodes 34 prevent the flow of electrical current in both directions. A second cross-module pair 42b of MOSFET switches 26c and 24d are electrically coupled so that the body diodes 34 prevent the flow of electrical current in both directions. And a third cross-module pair 42c of MOSFET switches 24e and 26g are electrically coupled so that the body diodes 34 prevent the flow of electrical current in both directions.

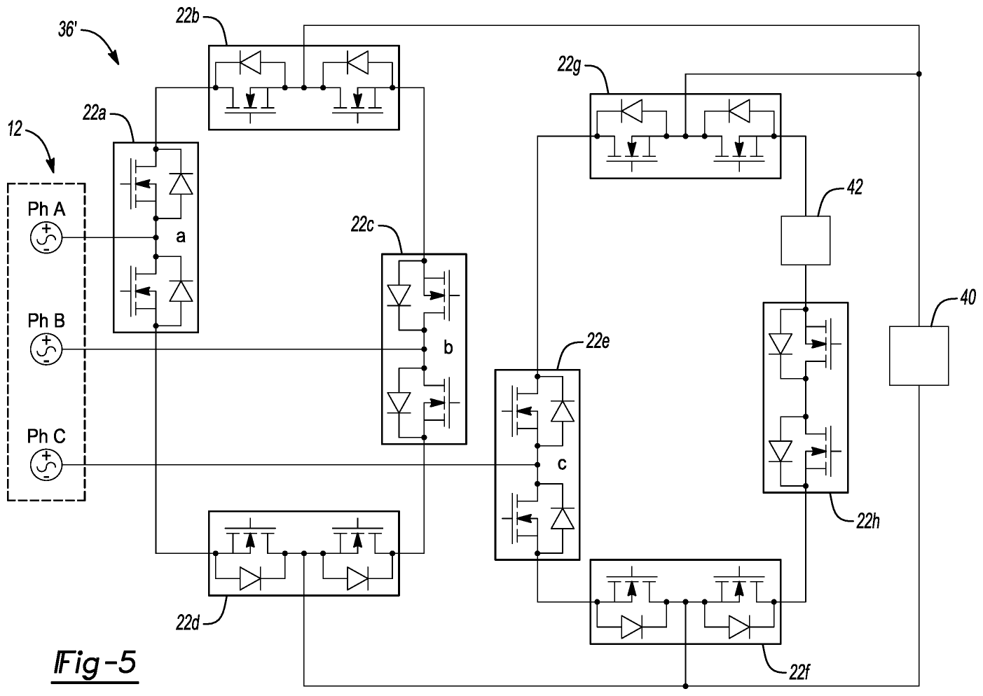

FIG. 5 depicts another implementation of the matrix converter 36′ including eight MOSFET modules 22a-22h. The matrix converter 36′ can be a direct matrix converter that includes a dedicated MOSFET 22h module for controlling the application of an electrical load 42 on the matrix converter 36′.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A stationary vehicle battery charger for charging vehicle batteries in battery electric vehicles (BEVs), comprising:
a plurality of MOSFET modules, electrically connected to form a matrix converter, comprising a plurality of MOSFET switches, each MOSFET switch including a body diode and capable of bidirectional electrical current flow while the MOSFET switch is conductive, wherein a MOSFET switch from a first MOSFET module and a MOSFET switch from a second, different MOSFET module are electrically coupled so that the body diodes prevent bidirectional current flow while the MOSFET switch from the first MOSFET module and the MOSFET from the second, different MOSFET module are non-conductive.

2. The stationary vehicle battery charger recited in claim 1, wherein the matrix converter is an AC-AC converter.

3. The stationary vehicle battery charger recited in claim 1, wherein the matrix converter is a direct matrix converter.

4. The stationary vehicle battery charger recited in claim 1, wherein the matrix converter is an indirect matrix converter.

5. The stationary vehicle battery charger recited in claim 1, wherein the MOSFET switches are Silicon Carbide (SiC) switches.

6. The stationary vehicle battery charger recited in claim 1, wherein the matrix converter comprises seven or more MOSFET switches.

7. The stationary vehicle battery charger recited in claim 1, wherein the plurality of MOSFET modules are half-bridge modules.

8. The stationary vehicle battery charger recited in claim 1, wherein the matrix converter comprises eight or more MOSFET switches.

9. A stationary vehicle battery charger for charging vehicle batteries in battery electric vehicles (BEVs), comprising:
a plurality of MOSFET switch pairs, each electrically configured to form a half bridge, and the plurality of MOSFET switch pairs electrically connected to form a matrix converter, each MOSFET switch of the plurality of MOSFET switch pair including a body diode and capable of bidirectional electrical current flow while the MOSFET switch is conductive, wherein a MOSFET switch from a first MOSFET switch pair and a MOSFET switch from a second, different MOSFET switch pair are electrically coupled so that the body diodes prevent bidirectional current flow while the MOSFET switch from the first MOSFET switch pair and the MOSFET switch from the second, different MOSFET switch pair are non-conductive.

10. The stationary vehicle battery charger recited in claim 9, wherein the matrix converter is an AC-AC converter.

11. The stationary vehicle battery charger recited in claim 9, wherein the matrix converter is a direct matrix converter.

12. The stationary vehicle battery charger recited in claim 9, wherein the matrix converter is an indirect matrix converter.

13. The stationary vehicle battery charger recited in claim 9, wherein the MOSFET switches are Silicon Carbide (SiC) switches.

14. The stationary vehicle battery charger recited in claim 9, wherein the matrix converter comprises seven or more MOSFET switches.

15. The stationary vehicle battery charger recited in claim 9, wherein the matrix converter comprises eight or more MOSFET switches.
